(19) United States
(12) Patent Application Publication
(10) Pub. No.: US 2008/0243893 A1
(43) Pub. Date: Oct. 2, 2008

(54) IMAGE MANAGING SYSTEM, DIGITAL CAMERA, IMAGE MANAGING METHOD, AND COMPUTER READABLE MEDIUM STORING AN IMAGE MANAGING PROGRAM

(76) Inventor: Masako SUEHIRO, Saitama-ken (JP)

Correspondence Address: BIRCH STEWART KOLASCH & BIRCH, PO BOX 747, FALLS CHURCH, VA, 22040-0747, US

(21) Appl. No.: 11/952,381

(22) Filed: Dec. 7, 2007

(30) Foreign Application Priority Data
Mar. 27, 2007 (JP) 2007-082879

(51) Int. Cl. G06F 7/00; G06F 3/048

(52) U.S. Cl. 707/101; 715/838; 707/E17.019; 707/E17.044

(57) ABSTRACT

In an image managing system, a digital camera has a photographing section, a first memory, a display, an importance degree acquiring section and an outputting section, and an information processing device has an inputting section, a second memory, and a controller. The first memory of the digital camera stores image information acquired by the photographing section. The importance degree acquiring section acquires importance degree information expressing a degree of importance of a photographed subject image expressed by stored image information. The stored image information and the importance degree information are outputted, and are inputted to the inputting section of the information processing device. The second memory stores inputted image information. The controller effects control such that, among the image information stored in the first memory, at least image information whose importance degree information is less than or equal to a predetermined value is deleted from the first memory, and at least deleted image information is stored in the second memory.

### CROSS-REFERENCE TO RELATED APPLICATION

This application claims priority under 35 USC 119 from Japanese Patent Application No. 2007-082879, the disclosure of which is incorporated by reference herein.

### BACKGROUND OF THE INVENTION

1. Field of the Invention

The present invention relates to an image managing system, a digital camera, an image managing method, and a computer readable medium storing an image managing program. In particular, the present invention relates to an image managing system, a digital camera, an image managing method, and a computer readable medium storing an image managing program, which output image information stored in a digital camera to an information processing device.

2. Description of the Related Art

Digital still cameras and digital video cameras have come into wide use as photographing devices which carry out photographing of an image by using a photographing element such as a CCD (Charge Coupled Device) or the like, and generate image information in accordance with the photographed image. In a digital still camera (hereinafter called digital camera) or the like, image information of a photographed image in which a subject is photographed is stored in a storage medium such as, for example, a portable memory card or the like.

The storage capacity of a memory card of a digital camera is not sufficient to storage a large amount of image information. Therefore, in order to ensure free storage capacity of a memory card, for example, the image information is transmitted to a storage device such as an HDD (Hard Disk Device) of a personal computer or the like, and is deleted from the memory card.

However, because digital cameras can be carried around, there are cases in which the need arises for the user of the digital camera to confirm, at the digital camera and at a later date, image information which was acquired by photographing in the past. In this case, if all of the image information acquired at the digital camera is stored in a storage medium of a personal computer or the like and the image information is deleted from the digital camera on all such occasions, the user cannot confirm these image information at the digital camera.

Japanese Patent Application Laid-Open (JP-A) No. 2004-147234 discloses a technique of, among the image information which are stored in the storage medium of the digital camera and have been transmitted to an external storage device, deleting the image information from the storage medium of the digital camera in order from the oldest date/time of photographing.

Further, JP-A No. 2006-229444 discloses a technique of evaluating image information on the basis of the number of times of display, the number of times of printing, the number of times of transfer, or the like of the image information, and, in accordance with the results of evaluation, carrying out image management which includes the deletion and compression of image information.

However, in the technique disclosed in JP-A No. 2004-147234, the image information are deleted from the digital camera unconditionally in accordance with the photographing date/time thereof and therefore, there are cases in which image information having high degrees of importance also are deleted. Further, in the technique disclosed in JP-A No. 2006-229444, there is the possibility that image information which receive a low evaluation will be deleted regardless of whether or not they have been transmitted to an external storage medium.

### SUMMARY OF THE INVENTION

The present invention has been made in view of the above circumstances and provides an image managing system, a digital camera, an image managing method, and a computer readable medium storing an image managing program.

According to an aspect of the invention, there is provided an image managing system comprising: a digital camera comprising: a photographing section photographing a subject and acquiring image information expressing a photographed subject image; a first memory storing the image information acquired by the photographing section; a display displaying the image information; an importance degree acquiring section acquiring, for each of the image information stored in the first memory, importance degree information expressing a degree of importance of the photographed subject image which is expressed by the image information stored by the first memory; and an outputting section outputting the image information stored in the first memory and the importance degree information, and an information processing device comprising: an inputting section inputting the image information and the importance degree information outputted from the outputting section; a second memory storing the image information inputted by the inputting section; and a controller effecting control such that, among the image information stored in the first memory, at least image information whose importance degree information is less than or equal to a predetermined value is deleted from the first memory, and at least the deleted image information is stored in the second memory.

### BRIEF DESCRIPTION OF THE DRAWINGS

Preferred embodiments of the present invention will be described in detail based on the following figures, wherein:

FIG. 1 is a block diagram showing the schematic structures of a digital camera and a personal computer to which the digital camera is connected;

FIG. 2 is a schematic drawing of image information which is made to be an Exif electronic file;

FIGS. 3A through 3C are examples of schematic drawings of a file list for managing image information stored in a memory card of a digital camera relating to a first embodiment;

FIG. 4 is a flowchart showing the flow of processing of a total displayed time recording program executed by a CPU of the digital camera relating to the first embodiment;

FIG. 5 is a flowchart showing the flow of processing of an image information transferring program executed by a CPU of a personal computer relating to the first embodiment;

FIGS. 6A and 6B are external views of a digital camera in a case in which image information, at which favorite marks relating to a second embodiment are set, are displayed as thumbnail images on an LCD;

FIG. 7 is a flowchart showing the flow of processing of an image information transferring program executed by a CPU of a personal computer relating to the second embodiment;

FIG. 8 is a flowchart showing the flow of processing of an image information transferring program executed by a CPU of a personal computer relating to a third embodiment;

FIG. 9 is a flowchart showing the flow of processing of an image information transferring program executed by a CPU of a personal computer relating to a fourth embodiment; and

FIG. 10 is a flowchart showing the flow of processing of an image information transferring program executed by a CPU of a personal computer relating to a fifth embodiment.

### DETAILED DESCRIPTION OF THE INVENTION

### First Embodiment

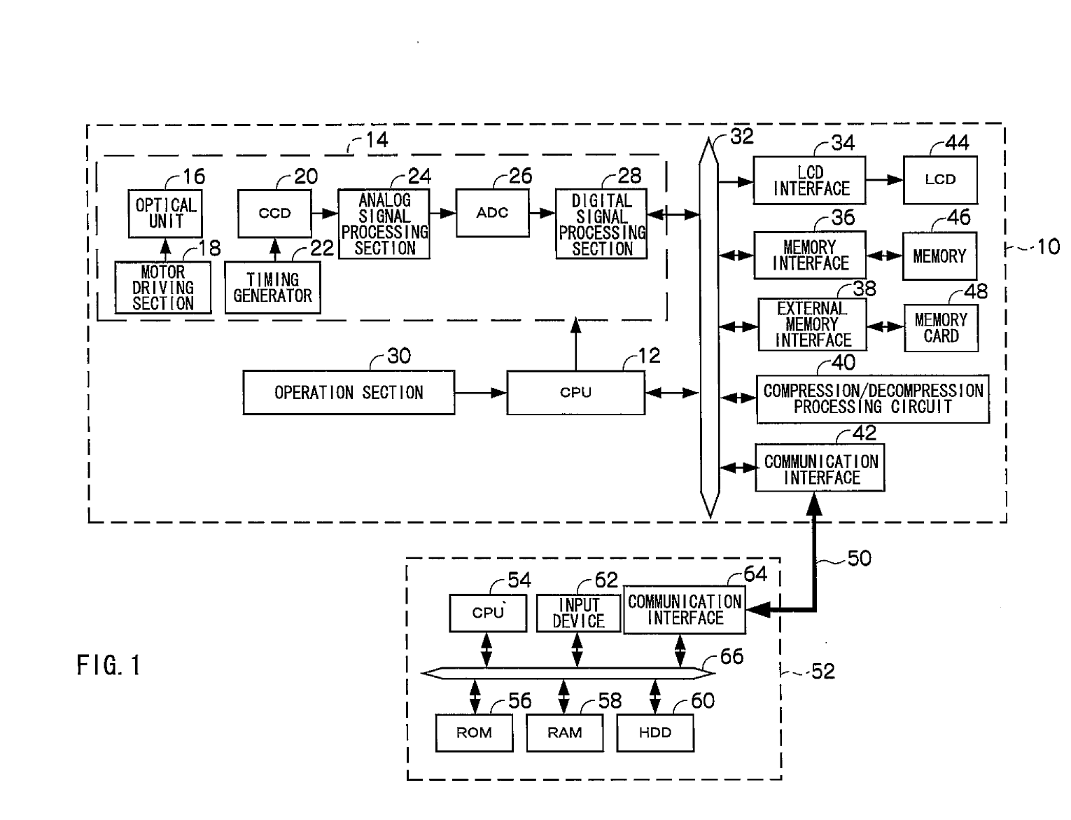

The structure of an electrical system of a digital camera 10 relating to the present embodiment will be described with reference to FIG. 1.

The digital camera 10 has a CPU (Central Processing Unit) 12 which governs the overall control of the digital camera 10.

The CPU 12 is connected to a photographing section 14.

The photographing section 14 has an optical unit 16. The optical unit 16 has plural lenses, and is structured as a zoom lens whose focal length can be changed (magnification can be changed), and focuses a photographed subject image. Note that the optical unit 16 is controlled by the CPU 12 via a motor driving section 18.

A CCD 20 is disposed at the rear side of the optical axis of the optical unit 16. The CCD 20 photoelectrically converts the light signal of the photographed subject which was focused at the optical unit 16, so as to convert it to an analog signal. The CCD 20 is connected to a timing generator 22. On the basis of control by the CPU 12, the timing generator 22 generates timing signals for driving the CCD 20. The output end of the CCD 20 is connected to an analog signal processing section 24. The analog signal, which relates to the photographed subject and which the CCD 20 generates by photoelectric conversion, is sent to the analog signal processing section 24.

The analog signal processing section 24 is structured so as to include a correlated double sampling circuit (hereinafter called “CDS”). The correlated double sampling processing by the CDS is a processing that obtains accurate pixel data by computing the difference between the feed-through component level and the pixel signal component level which are included in the output signal of each one pixel of the CCD 20, in order to reduce noise and the like which are included in the output signal of the CCD 20. The output end of the analog signal processing section 24 is connected to the input end of an analog/digital converter (hereinafter called “ADC”) 26 which converts analog signals into digital signals. The analog signals, which have been subjected to correlated double sampling processing by the CDS, are sent to the ADC 26.

The ADC 26 converts the inputted analog signals into image information which is digital data. The output end of the ADC 26 is connected to the input end of a digital signal processing section 28.

The digital signal processing section 28 has a line buffer of a predetermined capacity built therein, and carries out control to directly store the inputted image information in a predetermined region of a memory 46 which will be described later, and carries out various types of image processing on the image information.

Further, the CPU 12 is connected to the photographing section 14 which has various types of buttons and switches such as a release button, a power switch, a mode switching switch, a cross-shaped cursor button, and the like. The CPU 12 can always grasp the operational state of an operation section 30 by the user.

Via a bus 32, the CPU 12 is connected to an LCD (Liquid Crystal Display) interface 34, a memory interface 36, an external memory interface 38, a compression/decompression processing circuit 40, and a communication interface 42.

The LCD interface 34 generates signals for displaying images based on image information, menu screens, and the like on an LCD 44.

The memory interface 36 carries out control of access to the memory 46. The memory 46 temporarily stores mainly the image information obtained by photographing, and the like.

The external memory interface 38 can access a memory card 48 at the digital camera 10. The memory card 48 is a portable, non-volatile storage medium, and stores image information generated at the digital camera 10.

The compression/decompression processing circuit 40 carries out compression processing in a predetermined compression format on image information, and, on the other hand, carries out decompression processing corresponding to the compression format on image information which was subjected to compression processing.

The communication interface 42 relays the sending and receiving of various types of data to and from a personal computer 52 via, for example, a USB (Universal Serial Bus) transfer path 50. The digital camera 10 and the personal computer 52 are connected by the USB transfer path 50 which is structured by a USB cable, and the sending and receiving of various types of data between the digital camera 10 and the personal computer 52 via the USB transfer path 50 is possible.

The personal computer 52 has a CPU 54. The CPU 54 carries out computing processing on various types of inputted data, and is connected via a bus 66 to a ROM (Read Only Memory) 56, a RAM (Random Access Memory) 58, an HDD (Hard Disk Drive) 60, an input device 62, and a communication interface 64.

The CPU 54 reads-out various types of programs from the ROM 56 in accordance with processing, and carries out writing and reading of various types of data and various types of programs to and from the RAM 58.

The HDD 60 stores image information which is sent-in from the digital camera 10, and various types of data created at the personal computer 52.

The communication interface 64 is connected to the communication interface 42 of the digital camera 10 via the USB transfer path 50, and carries out sending and receiving of data such as image data and the like.

The input device 62 can be structured by a keyboard, a mouse and the like which are operated by the user in order to input various types of instructions to the CPU 54 of the personal computer 52.

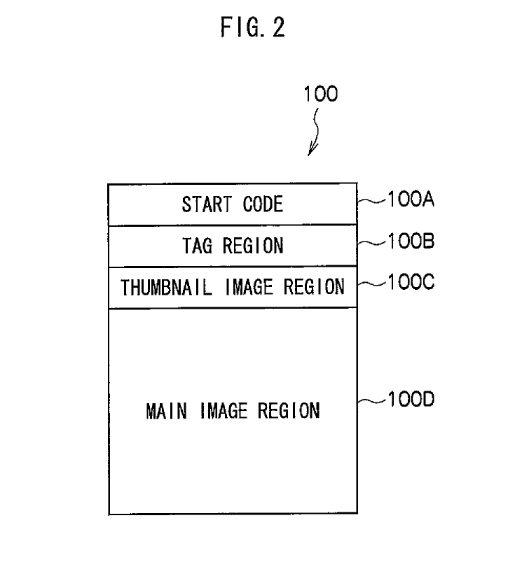

Note that the image information which is acquired at the photographing section 14 of the digital camera 10 may be stored in the memory card 48 as an Exif (Exchangeable Image File Format) electronic file 100 such as shown as a schematic drawing in FIG. 2. The Exif electronic file 100 is structured by a start code 100A, a tag region 100B, a thumbnail image region 100C, and a main image region 100D. Various types of information which are set in advance are stored in the tag region 100B. Further, image information expressing the photographed subject image is stored in the main image region 100D.

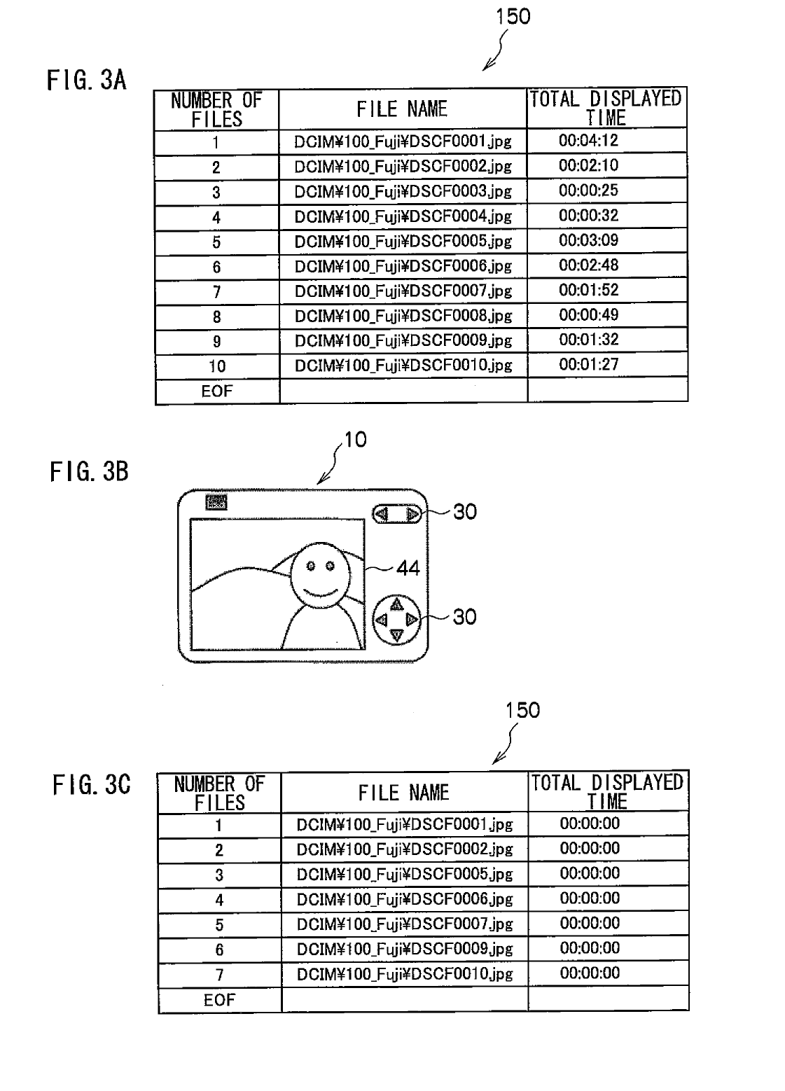

An example of a file list 150 for managing image information stored in the memory card 48 of the digital camera 10 is shown in FIG. 3A as a schematic drawing. Note that the file list 150 is stored in the memory 46 or the memory card 48.

The file list 150 stores the number of and file names of the image information stored in the memory card 48, and data expressing the total displayed time of each image information. The total displayed time is the total time that an image information stored in the memory card 48 is full-screen-displayed on the LCD 44 as shown in FIG. 3B and not in a thumbnail list. Image information that have longer total times of being displayed on the LCD 44 can be thought to have higher degrees of importance for the user.

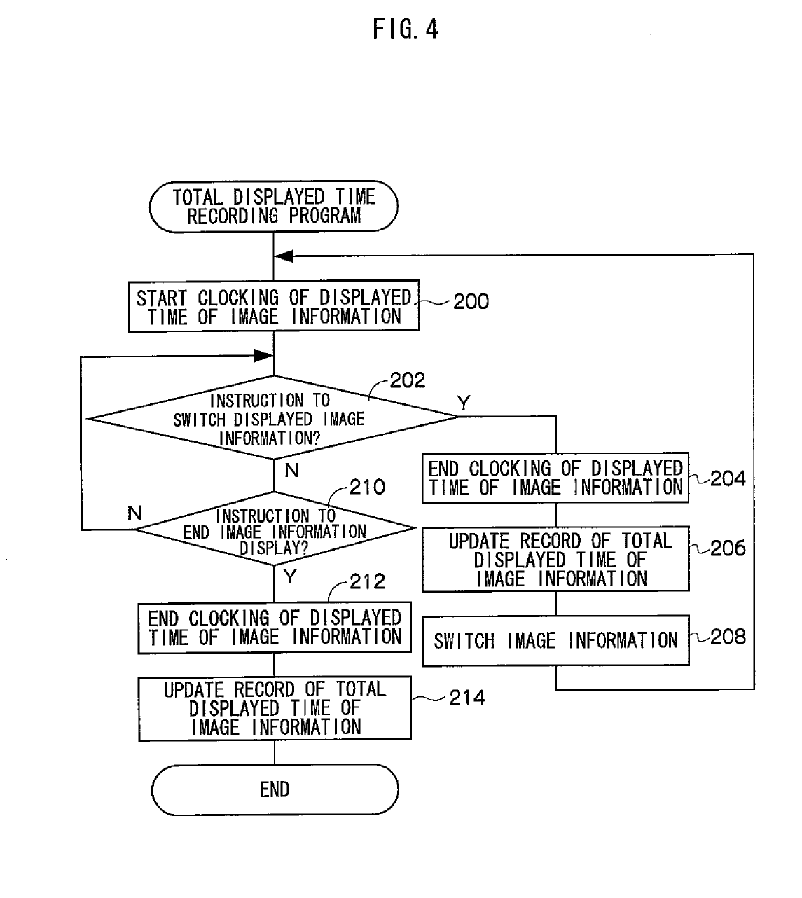

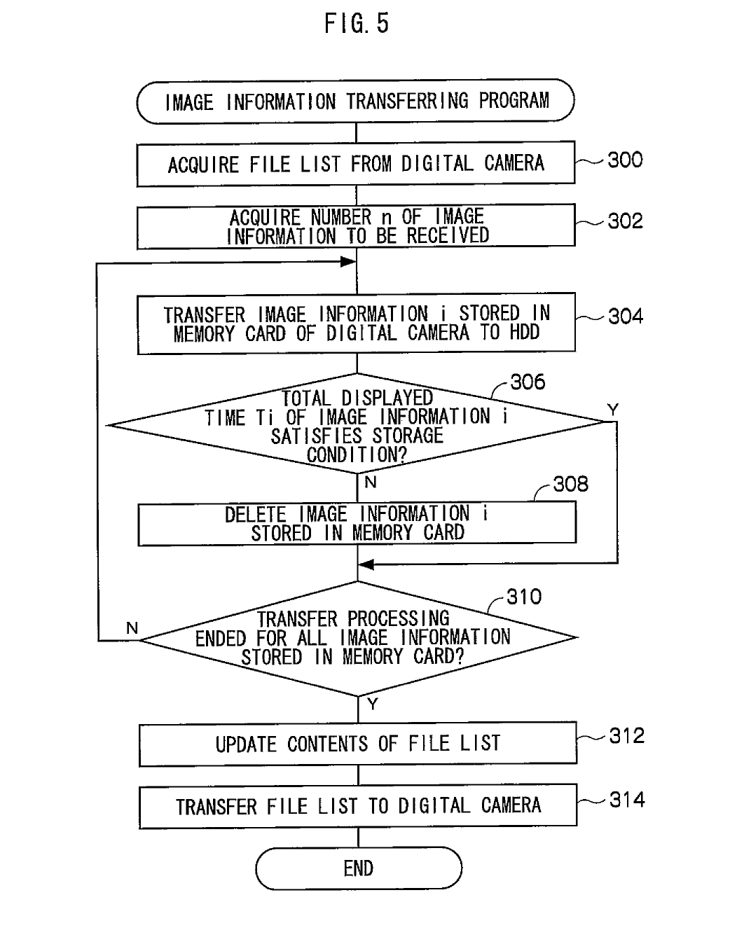

Operation relating to the present embodiment will be described next with reference to FIG. 4 and FIG. 5.

FIG. 4 is a flowchart showing the flow of processing of a total displayed time recording program which is executed by the CPU 12 of the digital camera 10. This program is executed by the CPU 12 of the digital camera 10 at the time when image information is full-screen-displayed on the LCD 44 of the digital camera 10 in a playback mode in which image information stored in the memory card 48 is played-back on the LCD 44.

First, in step 200, clocking of the displayed time of the image information displayed on the LCD 44 is started by an unillustrated soft timer which the CPU 12 of the digital camera 10 has.

Next, in step 202, it is judged whether or not an instruction to switch the image information displayed on the LCD 44 is inputted via the operation section 30 or the like. If a switching instruction is inputted, the routine moves on to step 204. On the other hand, if a switching instruction is not inputted, the routine moves on to step 210.

In step 204, the clocking of the displayed time of the image information displayed on the LCD 44 is ended.

Next, in step 206, the total displayed time, which is recorded in the file list 150, of the image information which was displayed on the LCD 44 is updated. In this way, the total displayed time is updated per image information.

Next, in step 208, switching of the image information displayed on the LCD 44 is carried out on the basis of the inputted switching instruction.

Step 210 is a case in which an instruction to switch the image information is not inputted, and it is judged whether or not an instruction to end display of the image information is inputted via the operation section 30 or the like. The display end instruction is a case in which the playback mode of the image information is ended and the mode proceeds to a photographing mode in which photographing of a subject is carried out, or the like. If a display end instruction is inputted, the routine advances to step 212. On the other hand, if a display end instruction is not inputted, the routine moves on to step 202, and clocking of the displayed time of the displayed image information is continued until a switching instruction or a display end instruction of the image information is inputted.

In step 212, clocking of the displayed time of the image information displayed on the LCD 44 is ended.

Next, in step 214, the total displayed time, which is recorded in the file list 150, of the image information which was displayed on the LCD 44 is updated, and the present program ends.

FIG. 5 is a flowchart showing the flow of processing of an image information transferring program executed by the CPU 54 of the personal computer 52. This program is executed by the CPU 54 of the personal computer 52 when the image information, which is stored in the memory card 48 of the digital camera 10, is to be transferred to the HDD 60 of the personal computer 52.

First, in step 300, the file list 150, which is stored in the memory 46 or the memory card 48 of the digital camera 10, is acquired via the USB transfer path 50.

Next, in step 302, the personal computer 52 acquires a number n of image information to be received from the digital camera 10. The number n of image information may be acquired by directly retrieving the number of image information that the memory card 48 of the digital camera 10 stores, or may be acquired from the file list 150 acquired in step 300.

Subsequently, in step 304, an image information i, which is stored in the memory card 48 of the digital camera 10, is transferred to the HDD 60 of the personal computer 52.

Next, in step 306, it is judged whether or not a total displayed time Ti of the image information i satisfies a storage condition for keeping the image information stored in the memory card 48 of the digital camera 10. If the storage condition is satisfied, the routine move on to step 310. On the other hand, if the storage condition is not satisfied, the routine proceeds to step 308.

Examples of the storage condition are the total displayed time of the image information being greater than or equal to X minutes, the image information being within the top Y in order of the longest total displayed times among the image information stored in the memory card 48, the image information being within the top Z % in order of the longest total displayed times among the image information stored in the memory card 48, and the like. Note that the present embodiment may be structured such that the user can set the storage condition in advance.

In step 308, the image information i which is stored in the memory card 48 of the digital camera 10 is deleted.

In step 310, it is judged whether or not transfer processing has ended for all of the image information stored in the memory card 48 of the digital camera 10. If all of the image information have been transferred, the judgment is affirmative and the routine proceeds to step 312. On the other hand, if not all of the image information have been transferred, the routine moves on to step 304 and transfer processing is carried out for the remaining image information.

In step 312, the contents of the file list 150 are updated so as to correspond to the image information remaining in the memory card 48 of the digital camera 10, as shown in FIG. 3C for example. FIG. 3C shows a case in which the image information whose total displayed times are greater than or equal to one minute are kept as is in the memory card 48. At this time, the total displayed times may be reset as shown in FIG. 3C.

Next, in step 314, the updated file list 150 is transferred to the digital camera 10, and is stored in the memory 46 or the memory card 48.

Note that, although the file list 150 which shows the total displayed time per image information is provided in the present embodiment, the present embodiment is not limited to the same. If the image information are Exif electronic files, the total displayed time per image information may be appropriately recorded in and read-out from the tag regions 100B.

As described above, the image information stored in the memory card 48 of the digital camera 10 are transferred to the personal computer 52 and stored in the HDD 60, and, on the other hand, among the image information stored in the memory card 48, the image information having longer total displayed times of being displayed on the LCD 44 are judged to be image information having higher degrees of importance and are retained in the memory card 48.

In this way, even though the image information stored in the memory card 48 are transferred to the personal computer 52, it is possible to keep only the image information that have high degrees of importance in the memory card 48 of the digital camera 10. Therefore, the user can confirm, at the digital camera 10, the image information which have high degrees of importance. Further, because the image information which have low degrees of importance are deleted from the memory card 48, even more free storage capacity of the memory card 48 can be ensured.

### Second Embodiment

Next, a case in which instruction information (e.g., a favorite mark) is given as importance degree information to the image information stored in the memory card 48 of the digital camera 10, will be described as a second embodiment. Note that the structure of the digital camera 10 relating to the second embodiment is similar to that of the first embodiment, and therefore, description thereof will be omitted.

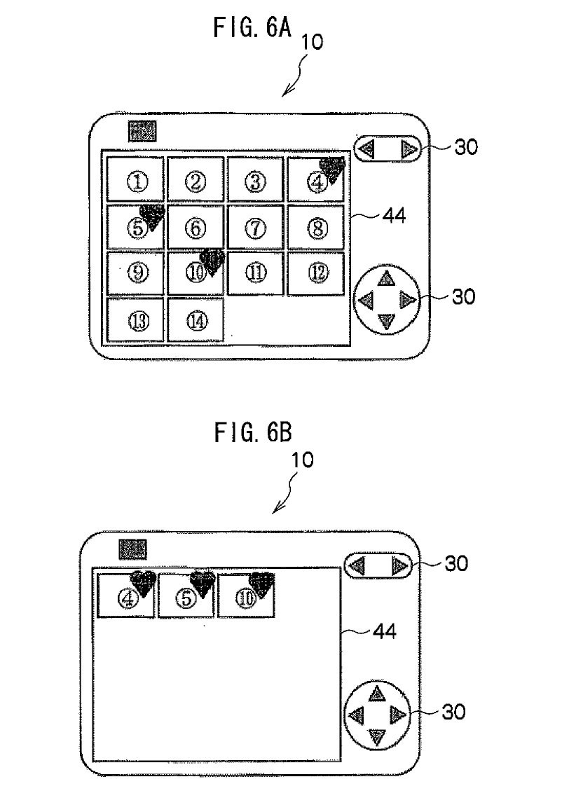

In the case of giving a favorite mark to image information, the user selects image information which has a high degree of importance by using the operation section 30, and sets a favorite mark for the selected image information. The CPU 12 of the digital camera 10 that receives this operation records instruction information, which expresses that a favorite mark has been added, in the tag region 10B (see FIG. 2) of the Exif image information. In this way, as shown in FIG. 6A, when the image information stored in the memory card 48 are displayed as thumbnail images on the LCD 44 of the digital camera 10, they are displayed with, for example, a heart-shaped favorite mark given to the upper right of the thumbnail image. FIG. 6A shows a state in which a favorite mark is set at image information numbers 4, 5 and 10.

A case in which image information is transferred from the memory card 48 of the digital camera 10 to the HDD 60 of the personal computer 52 will be described next.

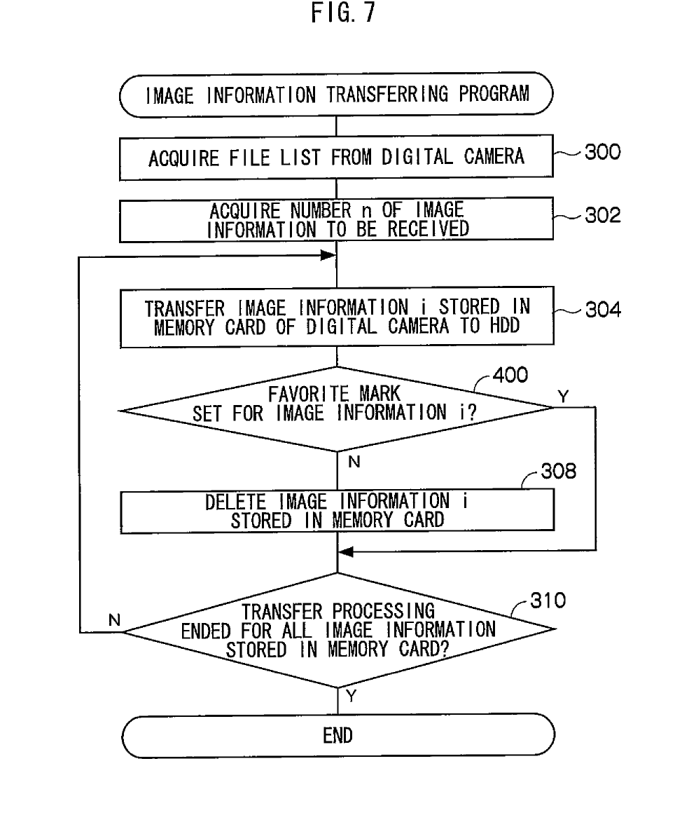

FIG. 7 is a flowchart showing the flow of processing of an image information transferring program which is executed by the CPU 54 of the personal computer 52. This flowchart is executed by the CPU 54 of the personal computer 52 when image information stored in the memory card 48 of the digital camera 10 is to be transferred to the HDD 60 of the personal computer 52. Note that, among the steps which are the same as those of the flowchart of FIG. 5 relating to the first embodiment, only those which are before and after additional steps will be described. Other steps which are the same are denoted by the same reference numerals, and description thereof is omitted.

After image information i stored in the memory card 48 of the digital camera 10 is transferred to the HDD 60 of the personal computer 52 in step 304, in step 400, it is judged whether or not a favorite mark is set at the image information i. If a favorite mark is set at the image information i, the routine moves on to step 310 where it is judged whether or not transfer processing is ended for all of the image information stored in the memory card 48. If it is judged that the transfer processing is not ended, the routine moves on to step 304. If it is judged that the transfer processing is ended, the image information transferring program ends. On the other hand, if a favorite mark is not set at the image information i, the routine moves on to step 308 where the image information i stored in the memory card 48 is deleted.

Then, when the image information, which are stored in the memory card 48 of the digital camera 10 after the image information transferring processing program shown in FIG. 7 ends, are displayed as thumbnail images, only the image information for which favorite marks are set (e.g., numbers 4, 5 and 10) are displayed as shown in FIG. 6B.

As described above, by using the operation section 30, the user can set a favorite mark, which expresses that image information is to be kept in the memory card 48, for image information which is stored in the memory card 48 of the digital camera 10 and which has a high degree of importance. In this way, even though the image information stored in the memory card 48 is transferred to the personal computer 52, it is possible to keep only the image information which have high degrees of importance in the memory card 48 of the digital camera 10. Therefore, the user can confirm, at the digital camera 10, the image information which have high degrees of importance. Further, because the image information which have low degrees of importance are deleted from the memory card 48, even more free storage capacity of the memory card 48 can be ensured.

### Third Embodiment

The third embodiment describes an example of a case in which a numerical point value which expresses the degree of importance of image information is added to the image information. Note that, because the structure of the digital camera 10 relating to the third embodiment is similar to that of the first embodiment, description thereof is omitted.

A numerical point value (recommendation score) which expresses the degree of importance of image information is added to each image information stored in the memory card 48, on the basis of at least one of the interval between the acquisition times of the corresponding image information and the image information which was acquired before that, the absence/presence of face(s) of person(s) with respect to the corresponding image information, and the extent of out-of-focus of the photographed subject image expressed by the corresponding image information.

The adding of the recommendation score will be described more concretely hereinafter.

The recommendation score is a total value expressing, by numerical points, each of the acquisition time interval, the absence/presence of face(s) of person(s), and the extent of out-of-focus. Inage information having shorter acquisition time intervals between image information are thought to be image information having higher degrees of importance for the user. For example, the shorter the acquisition time interval, the higher the numerical point. Further, the more the image information includes face(s) of person(s), the higher the degree of importance to the user that image information can be thought to have. For example, the number of faces of people, the size of the face(s), and whether or not the face(s) is/are facing frontward are expressed by numerical points. The higher the number of faces, and the larger the size of the face(s), and the greater the number of faces that are directed frontward, the higher the numerical point that is awarded. Moreover, image information having a smaller extent of out-of-focus can be thought to be image information having a higher degree of importance to the user. For example, the edges of the photographed subject image are detected, and the blurriness and shaking are judged on the basis thereof, and the less the blurriness and shaking of an image information, the higher the numerical point given thereto. In a case in which the image information is an Exif electronic file, the on/off state of the shake reduction function may be read-out and expressed as numerical points, or the set value relating to autofocus may be read-out and expressed as numerical points.

The numerical points corresponding to the acquisition time interval of the image information, the numerical points corresponding to the absence/presence of face(s) of person(s), and the numerical points corresponding to the extent of out-of-focus are added together so as to obtain the recommendation score for that image information. Namely, image information that has a higher recommendation score is judged to be image information that is more important to the user. Note that weighting may be carried out by multiplying the numerical points for the acquisition time interval, the numerical points for the absence/presence of face(s) of person(s), and the numerical points for the extent of out-of-focus by different factors and adding the respective products. Further, a standard other than acquisition time interval, absence/presence of face(s) of person(s) and extent of out-of-focus may be provided and added as numerical points of the recommendation score.

A case of transferring image information from the memory card 48 of the digital camera 10 to the HDD 60 of the personal computer 52 will be described next.

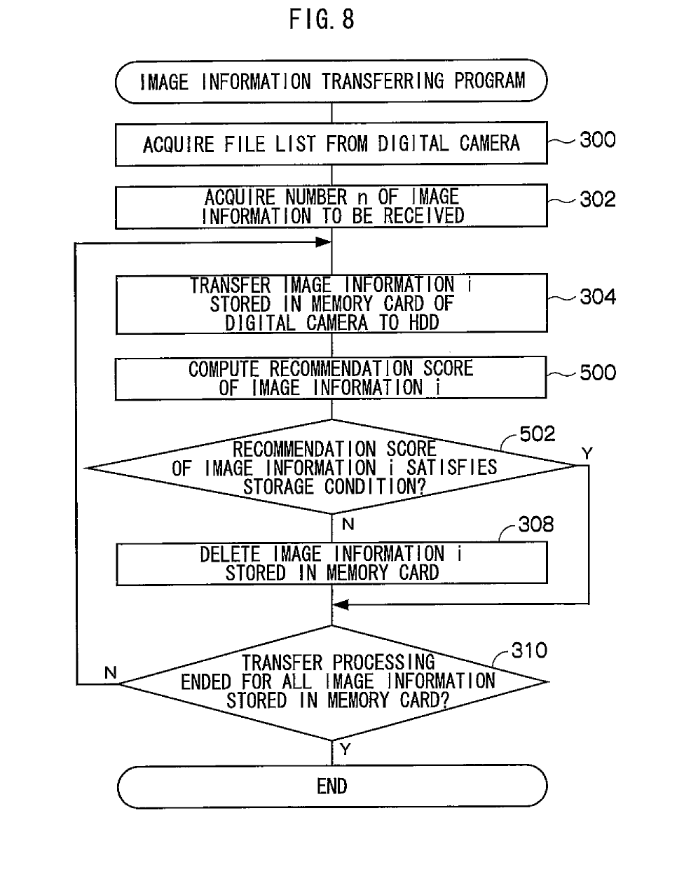

FIG. 8 is a flowchart showing the flow of processing of an image information transferring program executed by the CPU 54 of the personal computer 52. This flowchart is executed by the CPU 54 of the personal computer 52 when the image information stored in the memory card 48 of the digital camera 10 is to be transferred to the HDD 60 of the personal computer 52. Note that, among the steps which are the same as those of the flowchart of FIG. 5 relating to the first embodiment, only those which are before and after additional steps will be described. Other steps which are the same are denoted by the same reference numerals, and description thereof is omitted.

In step 304, the image information i which is stored in the memory card 48 of the digital camera 10 is transferred to the HDD 60 of the personal computer 52. Thereafter, in step 500, the recommendation score of the image information i is computed. Note that this computing of the recommendation score may be carried out at the CPU 12 of the digital camera 10, without being computed at the CPU 54 of the personal computer 52. Further, hardware for computing the recommendation score may be built-into the digital camera 10, and computation of the recommendation score may be carried out thereat. Moreover, in a case in which the recommendation score is computed at the digital camera 10, the recommendation score may be written into the file list 150, or, in a case in which the image information is an Exif electronic file, the recommendation score may be written, for example, to the tag region 100B for each image information.

Next, in step 502, it is judged whether or not the recommendation score of the image information i satisfies a storage condition. Examples of the storage condition are the recommendation score being greater than or equal to a predetermined numerical point value, the recommendation score being within the top X % among the recommendation scores of the image information stored in the memory card 48, and the like. If the recommendation score of the image information i satisfies the storage condition, the routine moves on to step 310 where it is judged whether or not transfer processing has ended for all of the image information stored in the memory card 48. If it is judged that the transfer processing has not ended, the routine moves on to step 304. If it is judged that the transfer processing has ended, the image information transferring program ends. On the other hand, if the recommendation score of the image information i does not satisfy the storage condition, the routine proceeds to step 308 where the image information i stored in the memory card 48 is deleted.

As described above, by adding a recommendation score to each image information at the personal computer 52 or at the digital camera 10, image information which are thought to be important to the user among the image information which are stored in the memory card 48 of the digital camera 10 can be kept in the memory card 48. In this way, even though the image information stored in the memory card 48 is transferred to the personal computer 52, it is possible to keep only the image information which have high degrees of importance in the memory card 48 of the digital camera 10, and even more free storage capacity of the memory card 48 can be ensured. Further, the user can confirm, at the digital camera 10, the image information which have high degrees of importance.

### Fourth Embodiment

Next, a case in which the image information which are retained in the memory card 48 of the digital camera 10 are stored with the image sizes thereof reduced will be described next as a fourth embodiment. Note that, because the structure of the digital camera 10 relating to the fourth embodiment is similar to that of the first embodiment, description thereof is omitted.

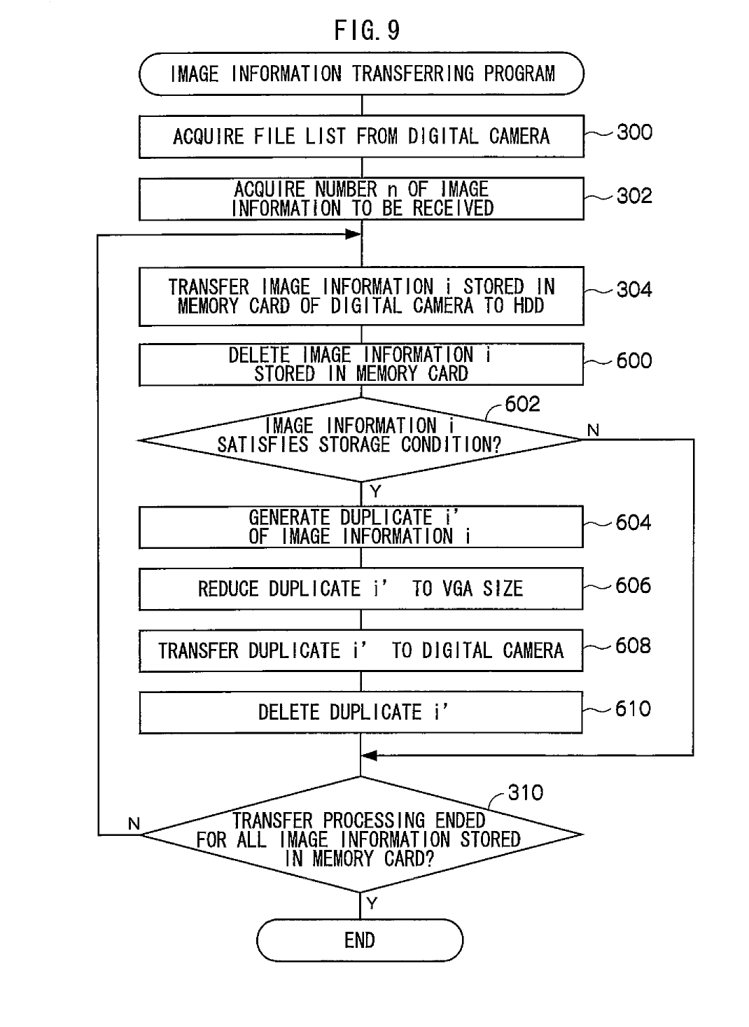

A case in which, when image information are transferred from the memory card 48 of the digital camera 10 to the HDD 60 of the personal computer 52, the image information are stored in the memory card 48 of the digital camera 10 with the image sizes thereof reduced, will be described next with reference to FIG. 9.

FIG. 9 is a flowchart showing the flow of processing of an image information transferring program executed by the CPU 54 of the personal computer 52. This flowchart is executed by the CPU 54 of the personal computer 52 when the image information stored in the memory card 48 of the digital camera 10 are to be transferred to the HDD 60 of the personal computer 52. Note that, among the steps which are the same as those of the flowchart of FIG. 5 relating to the first embodiment, only those which are before and after additional steps will be described. Other steps which are the same are denoted by the same reference numerals, and description thereof is omitted.

In step 304, image information i stored in the memory card 48 of the digital camera 10 is transferred to the HDD 60 of the personal computer 52. Thereafter, in step 600, the image information i which is stored in the memory card 48 is deleted.

Next, in step 602, it is judged whether or not the image information i satisfies the storage condition for being kept in the memory card 48 of the digital camera 10. This step corresponds to step 306 in the flowchart of FIG. 5 of the first embodiment, step 400 in the flowchart of FIG. 7 of the second embodiment, and step 502 in the flowchart of FIG. 8 of the third embodiment. If it is judged that the storage condition is satisfied, the routine moves on to step 604. On the other hand, if it is judged that the storage condition is not satisfied, the routine moves on to step 310 where it is judged whether or not transfer processing for all of the image information stored in the memory card 48 has ended. If it is judged that the transfer processing has not ended, the routine moves on to step 304. If it is judged that the transfer processing has ended, the image information transferring program ends.

In step 604, image information i′, which is a duplicate of the image information i, is generated and is temporarily stored in the RAM 58 of the personal computer 52.

Next, in step 606, if the image display size of the LCD 44 is, for example, VGA size (640×480 pixels), the image information i′ is reduced to VGA size. Note that the image size after reduction is not limited to VGA size, and it suffices for the image size to be a size which is sufficient for display on the LCD 44.

Subsequently, in step 608, the image information i′ is transferred from the RAM 58 of the personal computer 52 to the memory card 48 of the digital camera 10.

Next, in step 610, the image information i′ is deleted from the RAM 58 of the personal computer 52, and the routine moves on to step 310. If it is judged that the transfer processing has ended, the image information transferring program is ended.

Note that, in the case of making the present embodiment correspond to the first embodiment, step 312 and step 314 shown in FIG. 5 are incorporated in after step 310.

As described above, in accordance with the fourth embodiment, image information, which has a high degree of importance and is to be left in the memory card 48 of the digital camera 10, is reduced to a size which is sufficient for display on the LCD 44. Therefore, the data size of the image information which are kept in the memory card 48 can be made to be small, and, as compared with a case in which the image information are not reduced, even more free storage capacity of the memory card 48 can be ensured. Further, by making the image size small, the time required for switching in a case in which, for example, images are displayed by frame advance on the LCD 44, can be shortened.

### Fifth Embodiment

In the fifth embodiment, description will be given of an example in which protection is applied to image information, which have a high degree of importance and which are to be kept in the memory card 48 of the digital camera 10, so that these image information are not deleted from the memory card 48. Note that, because the structure of the digital camera 10 relating to the fifth embodiment is similar to that of the first embodiment, description thereof is omitted.

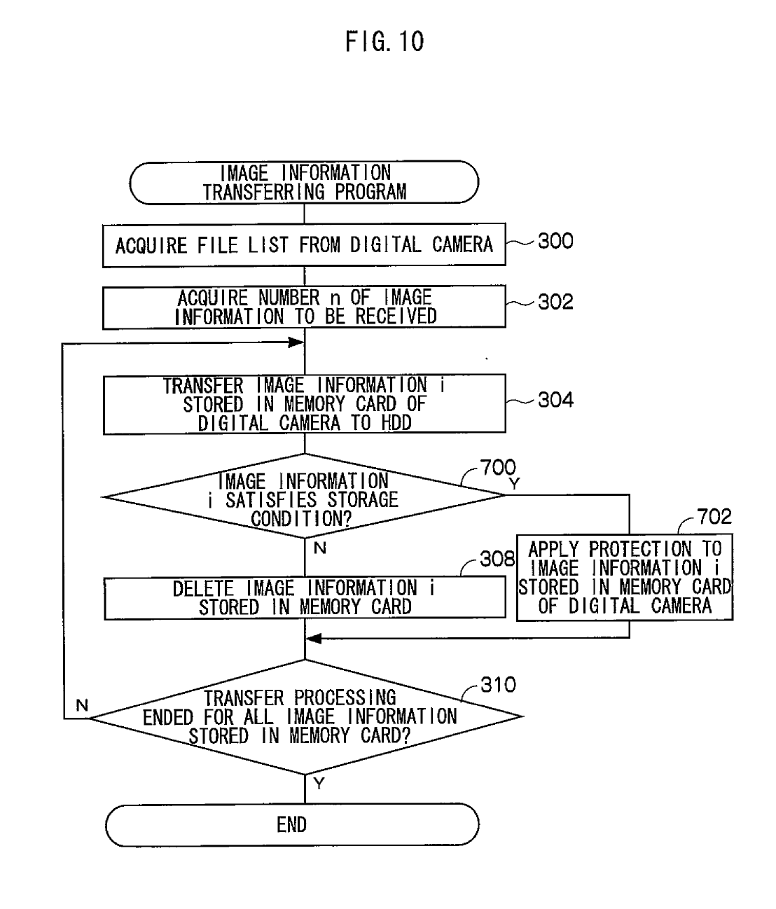

FIG. 10 is a flowchart showing the flow of processing of an image information transferring program which is executed by the CPU 54 of the personal computer 52. This flowchart is executed by the CPU 54 of the personal computer 52 when the image information stored in the memory card 48 of the digital camera 10 are to be transferred to the HDD 60 of the personal computer 52. Note that, among the steps which are the same as those of the flowchart of FIG. 5 relating to the first embodiment, only those which are before and after additional steps will be described. Other steps which are the same are denoted by the same reference numerals, and description thereof is omitted.

In step 304, the image information i which is stored in the memory card 48 of the digital camera 10 is transferred to the HDD 60 of the personal computer 52. Thereafter, in step 700, it is judged whether or not a favorite mark is set for the image information i. This step corresponds to step 306 in the flowchart of FIG. 5 of the first embodiment, step 400 in the flowchart of FIG. 7 of the second embodiment, and step 502 in the flowchart of FIG. 8 of the third embodiment. If it is judged that the storage condition is satisfied, the routine proceeds to step 702. On the other hand, if it is judged that the storage condition is not satisfied, the routine moves on to step 308, and the image information i which is stored in the memory card 48 is deleted.

In step 702, protection is applied to the image information i which is stored in the memory card 48 of the digital camera 10. In step 310, it is judged whether or not transfer processing has ended for all of the image information stored in the memory card 48. If it is judged that the transfer processing has not ended, the routine moves on to step 304. If it is judged that the transfer processing has ended, the image information transferring program ends.

Note that, in the case in which the present embodiment is used in the first embodiment, step 312 and step 314 shown in FIG. 5 are incorporated in after step 310.

As described above, in accordance with the fifth embodiment, the image information, which has a high degree of importance and which is to be retained in the memory card 48 of the digital camera 10, is protected. Therefore, the image information is not deleted from the memory card 48 provided that this protection is not cancelled. For example, a user can be prevented from mistakenly deleting an image information which has a high degree of importance from the memory card 48.

Note that, in the above-described respective embodiments, the processing of deleting the image information which does not satisfy the storage condition, among the image information which are stored in the memory card 48 of the digital camera 10, is carried out at the CPU 54 of the personal computer 52. However, this processing may be carried out at the CPU 12 provided at the digital camera 10.

In this case, in the first embodiment, after acquiring the number n of the image information which are to be transferred from the memory card 48 to the HDD 60 of the personal computer 52, the CPU 12 of the digital camera 10 may transfer the image information stored in the memory card 48 to the HDD 60. Then, the CPU 12 may, by referring to the file list 150, judge whether or not the total displayed time of each image information satisfies the storage condition, and delete from the memory card 48 the image information which do not satisfy the storage condition, and update the contents of the file list 150.

Further, in the second embodiment, after acquiring the number n of the image information which are to be transferred from the memory card 48 to the HDD 60 of the personal computer 52, the CPU 12 of the digital camera 10 may transfer the image information stored in the memory card 48 to the HDD 60. Then, the CPU 12 may judge whether or not a favorite mark is set at each of the image information, and delete from the memory card 48 the image information at which a favorite mark is not set.

In the third embodiment, after acquiring the number n of the image information which are to be transferred from the memory card 48 to the HDD 60 of the personal computer 52, the CPU 12 of the digital camera 10 may transfer the image information stored in the memory card 48 to the HDD 60. Then, the CPU 12 may judge whether or not the recommendation score of each of the image information satisfies the storage condition, and delete from the memory card 48 the image information which do not satisfy the storage condition.

Further, in the fourth embodiment, the CPU 12 of the digital camera 10 may reduce the image sizes of the image information which are kept in the memory card 48.

Moreover, in the fifth embodiment, the CPU 12 of the digital camera 10 may apply protection to the image information which are kept in the memory card 48, so that these image information are not deleted from the memory card 48.

Embodiments of the present invention are described above, but the present invention is not limited to these embodiments as will be clear to those skilled in the art.

According to a first aspect of the invention, there is provided an image managing system comprising: a digital camera comprising: a photographing section photographing a subject and acquiring image information expressing a photographed subject image; a first memory storing the image information acquired by the photographing section; a display displaying the image information; an importance degree acquiring section acquiring, for each of the image information stored in the first memory, importance degree information expressing a degree of importance of the photographed subject image which is expressed by the image information stored by the first memory; and an outputting section outputting the image information stored in the first memory and the importance degree information, and an information processing device comprising: an inputting section inputting the image information and the importance degree information outputted from the outputting section; a second memory storing the image information inputted by the inputting section; and a controller effecting control such that, among the image information stored in the first memory, at least image information whose importance degree information is less than or equal to a predetermined value is deleted from the first memory, and at least the deleted image information is stored in the second memory.

In accordance with the above-described first aspect, among the image information stored in the first memory of the digital camera, the image information whose importance degree information is less than or equal to a predetermined value is deleted from the first memory. In this way, image information having a high degree of importance can be retained in the first memory, and even more free storage capacity of the first memory can be ensured.

In the above-described first aspect, the importance degree information may be a total displayed time of the image information displayed on the display. In this way, image information, whose total displayed time of being displayed on the display is long for example, can be retained in the first memory as image information having a high degree of importance, and even more free storage capacity of the memory of the digital camera can be ensured.

In the above-described first aspect, the digital camera may further have a setting section that sets, as the importance degree information and for at least one of the image information stored in the first memory, instruction information expressing that the image information is to be retained in the first memory, and the controller may delete, from the first memory, image information for which the instruction information is not set. In this way, image information at which instruction information is set can be retained in the first memory as image information having a high degree of importance, and even more free storage capacity of the memory of the digital camera can be ensured.

In the above-described first aspect, the importance degree information may be a numerical point value added to each of the image information stored in the first memory, on the basis of at least one of an acquisition time interval between the corresponding image information and an image information acquired therebefore, a number of face(s) of person(s) in the corresponding image information, a size of the face(s), a number of the face(s) facing frontward, and an extent of out-of-focus of the photographed subject image expressed by the corresponding image information. In this way, image information, at which the numerical point added thereto is higher for example, can be retained in the first memory as image information having a higher degree of importance, and even more free storage capacity of the memory of the digital camera can be ensured.

In the above-described first aspect, there may further be provided a reducing section that reduces image information retained in the first memory to a predetermined image size. In this way, even though image information having a high degree of importance is retained in the first memory, even more free storage capacity of the first memory can be ensured.

In the above-described first aspect, there may further be provided a deletion preventing setting section carrying out setting such that the image information stored in the first memory is not deleted from the first memory. In this way, it is possible to prevent image information, which has a high degree of importance and is stored in the first memory, from being deleted mistakenly.

According to a second aspect of the invention, there is provided a digital camera comprising: a photographing section photographing a subject and acquiring image information expressing a photographed subject image; a first memory storing the image information acquired by the photographing section; an outputting section outputting, to an exterior, the image information stored in the first memory; an importance degree acquiring section acquiring, for each of the image information stored in the first memory, importance degree information expressing a degree of importance of the photographed subject image which is expressed by the image information stored by the first memory; and a controller effecting control such that, among the image information stored in the first memory, at least image information whose importance degree information is less than or equal to a predetermined value is deleted from the first memory, and at least the deleted image information is outputted by the outputting section to a second memory provided at the exterior.

In accordance with the above-described second aspect, image information having a high degree of importance is retained in the memory of the digital camera, and even more free storage capacity of the memory of the digital camera can be ensured.

According to a third aspect of the invention, there is provided an image managing method comprising: photographing a subject, and acquiring importance degree information expressing a degree of importance of a photographed subject image which is expressed by image information stored in a first memory, for each of the image information stored in the first memory; and deleting from the first memory at least image information whose importance degree information is less than or equal to a predetermined value among the image information stored in the first memory, and storing at least the deleted image information in a second memory.

In accordance with the above-described third aspect, image information having a high degree of importance is retained in the memory of the digital camera, and even more free storage capacity of the memory of the digital camera can be ensured.

According to a fourth aspect of the invention, there is provided a computer readable medium storing a program causing a computer to execute a process for managing image data, the process comprising: photographing a subject, and acquiring importance degree information expressing a degree of importance of a photographed subject image which is expressed by image information stored in a first memory, for each of the image information stored in the first memory; and deleting from the first memory at least image information whose importance degree information is less than or equal to a predetermined value among the image information stored in the first memory, and storing at least the deleted image information in a second memory.

In accordance with the above-described fourth aspect, image information having a high degree of importance is retained in the memory of the digital camera, and even more free storage capacity of the memory of the digital camera can be ensured.

As described above, in accordance with the aspects of the present invention, image information having a high degree of importance is retained in the memory of a digital camera, and even more free storage capacity of the memory of the digital camera can be ensured.

What is claimed is:

1. An image managing system comprising:
a digital camera comprising:
a photographing section photographing a subject and acquiring image information expressing a photographed subject image;
a first memory storing the image information acquired by the photographing section;
a display displaying the image information;
an importance degree acquiring section acquiring, for each of the image information stored in the first memory, importance degree information expressing a degree of importance of the photographed subject image which is expressed by the image information stored by the first memory; and
an outputting section outputting the image information stored in the first memory and the importance degree information, and
an information processing device comprising:
an inputting section inputting the image information and the importance degree information outputted from the outputting section;
a second memory storing the image information inputted by the inputting section; and
a controller effecting control such that, among the image information stored in the first memory, at least image information whose importance degree information is less than or equal to a predetermined value is deleted from the first memory, and at least the deleted image information is stored in the second memory.

2. The image managing system of claim 1, wherein the importance degree information is a total displayed time of the image information displayed on the display.

3. The image managing system of claim 2, wherein
the display has a thumbnail display which displays a plurality of image information and a full-screen-display which displays a single image information, and
the total displayed time is time that the image information is displayed on the display in the full-screen-display.

4. The image managing system of claim 1, wherein
the digital camera further comprises a setting section that sets, as the importance degree information and for at least one of the image information stored in the first memory, instruction information expressing that the image information is to be retained in the first memory, and
the controller deletes, from the first memory, image information for which the instruction information is not set.

5. The image managing system of claim 1, wherein the importance degree information is a numerical point value added to each of the image information stored in the first memory, on the basis of at least one of an acquisition time interval between the image information and an image information acquired before the image information, a number of face(s) of person(s) in the image information, a size of the face(s), a number of the face(s) facing frontward, and an extent of out-of-focus of the photographed subject image expressed by the image information.

6. The image managing system of claim 1, further comprising a reducing section that reduces image information retained in the first memory to a predetermined image size.

7. The image managing system of claim 6, wherein the reducing section is provided at the information processing device, and the controller causes the reduced image information to be stored in the first memory of the digital camera.

8. The image managing system of claim 1, further comprising a deletion preventing setting section carrying out setting such that at least one of the image information stored in the first memory is not deleted from the first memory.

9. The image managing system of claim 8, wherein the deletion preventing setting section is provided at the information processing device, and protects such that, among the image information stored in the first memory, image information whose importance degree information is greater than the predetermined value is not deleted from the first memory.

10. The image managing system of claim 1, wherein the image information is an Exif electronic file.

11. A digital camera comprising:
a photographing section photographing a subject and acquiring image information expressing a photographed subject image;
a first memory storing the image information acquired by the photographing section;
an outputting section outputting, to an exterior, the image information stored in the first memory;
an importance degree acquiring section acquiring, for each of the image information stored in the first memory, importance degree information expressing a degree of importance of the photographed subject image which is expressed by the image information stored by the first memory; and
a controller effecting control such that, among the image information stored in the first memory, at least image information whose importance degree information is less than or equal to a predetermined value is deleted from the first memory, and at least the deleted image information is outputted by the outputting section to a second memory provided at the exterior.

12. An image managing method comprising:
photographing a subject, and acquiring importance degree information expressing a degree of importance of a photographed subject image which is expressed by image information stored in a first memory, for each of the image information stored in the first memory; and
deleting from the first memory at least image information whose importance degree information is less than or equal to a predetermined value among the image information stored in the first memory, and storing at least the deleted image information in a second memory.

13. A computer readable medium storing a program causing a computer to execute a process for managing image data, the process comprising:
photographing a subject, and acquiring importance degree information expressing a degree of importance of a photographed subject image which is expressed by image information stored in a first memory, for each of the image information stored in the first memory; and
deleting from the first memory at least image information whose importance degree information is less than or equal to a predetermined value among the image information stored in the first memory, and storing at least the deleted image information in a second memory.
